(19) United States
(12) Patent Application Publication
(10) Pub. No.: US 2026/0023933 A1
(43) Pub. Date: Jan. 22, 2026

(54) Multi-Channel Intent Summarization Using Utterance Shift and Span Detection

(71) Applicant: OPTUM, INC., Minnetonka, MN (US)

(72) Inventors: Siddhant Srivastava, Uttar Pradesh (IN); Ankur Gulati, Haryana (IN); Tanmey Rawal, Haryana (IN); Aditya Teja Josyula, Collierville, TN (US)

(21) Appl. No.: 19/006,055

(22) Filed: Dec. 30, 2024

Related U.S. Application Data
(60) Provisional application No. 63/673,472, filed on Jul. 19, 2024.

(51) Int. Cl. G06F 40/35; G06N 3/0475; G06N 3/09

(52) U.S. Cl. CPC G06F 40/35; G06N 3/0475; G06N 3/09

(57) ABSTRACT

Techniques for summarizing conversations in real-time are disclosed. The techniques receive streaming data indicating a set of digital interactions between a first user and a second user. The techniques predict a span of time over which a portion of the set of digital interactions are associated with a first intent. The techniques classify a first intent classification associated with the portion of the set of digital interactions. The techniques then generate a first prompt based at least in part on the first intent classification and the portion of the set of digital interactions. The techniques generate a first summary of the set of digital interactions. The summary can then be displayed to a user, e.g., for review and/or editing. The process may repeat within any given digital interaction(s) for multiple intents. These techniques can enhance the accuracy and efficiency of interaction summarization, including summarization of complex, multi-intent interactions.

### CROSS-REFERENCE TO RELATED APPLICATIONS

This application claims the benefit of U.S. Provisional Patent Application No. 63/673,472, filed on Jul. 19, 2024, the entire disclosure of which is hereby incorporated herein by reference for any purposes. This application also incorporates by reference for any purposes the entire disclosure of U.S. Patent Application No. [Unassigned], titled “Multi-Channel Intent-Specific Communication Session Summarization”, filed Dec. 30, 2024.

### BACKGROUND

Contact centers handle a large volume of communications daily, and it is essential to document each interaction for quality assurance, compliance, and training purposes. Traditionally, advocates have been responsible for manually summarizing interactions, which is a time-consuming, inefficient, error-prone, and often inaccurate process. Existing summarization systems fall short in terms of accuracy (e.g., hallucinations), latency, and resilience (e.g., ability to handle input data with a wider variety of topics).

### BRIEF DESCRIPTION OF THE DRAWINGS

The FIGS. described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 depicts an example computing system in which various embodiments of the present disclosure may be implemented.

FIG. 2A depicts an example summarization flow, in accordance with various embodiments described herein.

FIG. 2B depicts an example summarization flow for multiple intents, in accordance with various embodiments described herein.

FIG. 2C depicts an example summarization flow with two or more of the same intent classification, in accordance with various embodiments described herein.

FIG. 2D depicts example interaction data and ground truth classification for an intent shift classification model, in accordance with various embodiments described herein.

FIG. 2E depicts example CRM data and ground truth classification for an intent classification model, in accordance with various embodiments described herein.

FIG. 3 depicts an example CRM graphical user interface (GUI), in accordance with various embodiments described herein.

FIG. 4 depicts a flow diagram representing an example computer-implemented method, in accordance with various embodiments described herein.

### DETAILED DESCRIPTION

Device and/or channel interaction summarization techniques for multi-intent interactions can be associated with numerous problems (e.g., inaccuracies in documentation, poor latency, and/or lack of resiliency for multi-intent interactions). Broadly speaking, the techniques of the present disclosure relate to techniques (e.g., hardware, software, machine-learned model(s), or a combination thereof; process(es)) for interaction summarization of multi-intent interactions with shift and intent classification with low latency, in an accurate and resilient manner.

Generally, the disclosed techniques can summarize an interaction (e.g., a device and/or channel interaction such as an interaction via a text, audio, and/or other I/O channel), or a portion thereof, by customizing a prompt for a generative model (e.g., a transformer-based machine-learned model) based on an intent shift and/or intent classification detected by one or more classification models (e.g., transformer-based models such as BERT, BART, T5, GPT, and/or the like). For example, during a user's interaction with a device or a first user's interaction with a second user, an intent classification model may use a user's first interaction and/or recent (in time) interactions of the first user and/or the second user to predict whether an intent classification associated with the first interaction has changed. An intent shift classification model may use a sequence of such intent classifications to predict a “shift start” to indicate the beginning of an interaction span. For example, the interaction span may indicate a start time and an end time where the predicted interactions were associated with a first intent classification. At a later time, the intent shift classification model may classify a later interaction or sequence of interactions as “shift end” to indicate that subsequent interaction(s) indicate a change in intent classification. An intent classification model may use the set of interactions contained within an interaction span to predict the set of interactions as being associated with one or more of a set of predefined intent classifications (e.g., “review medical benefits”). The disclosed techniques may then use the interaction span and the predicted intent classifications to generate a prompt that a generative model uses to generate a summary for the interaction span. In some examples, at least one of the users in the interaction may separately access a hosted service, such as a customer relationship management platform, ticketing/issue system, information system administration platform, and/or the like. Data indicating interactions of this user with such as service may be recorded as service interaction data. The prompt can also include additional information, such as the service interaction data, user metadata, and/or the like that provides the generative model with authoritative information to ensure the summary of the interaction span in the context of the classified intent is accurate. The summary can then be displayed to at least one of the users to review and optionally edit (e.g., revise the intent classification associated with an interaction span, modify the start and/or end times associated with the span, and/or edit and/or generate a revised summary).

As discussed, existing interaction summarization techniques can fall short in terms of accuracy, latency, and resilience. The techniques of the present disclosure have technical advantages over such techniques. By facilitating interaction summarization with classified intent shift(s) and intent classification(s), the disclosed techniques maintain various advantages of automated interaction summarization by enabling real-time generation of intent specific summaries while reducing the risk of hallucinations (e.g., an LLM misidentifying the user's intent), even for complex, multi-intent interactions. The real-time generation of summaries enhances the efficiency and effectiveness of interactions by providing instant insights into the nature and content of the interaction enabling, for example, faster and more efficient decision-making. The real-time summarization facilitates a dynamic and responsive interaction where summaries may be adjusted and refined in response to ongoing interactions. The disclosed techniques mitigate hallucinations and ensure accurate summaries by classifying intents, which prevents a generative model prompted with just the interaction from misidentifying the various intents discussed in complex interactions. Further, classifying intent shifts in utterances or other interaction portions ensures that the relevant portion of the interaction is used to generate a prompt, thus more accurately summarizing the various intents discussed on an interaction as a whole.

Moreover, by leveraging classification models during the interaction with respect to the timing of different intents being discussed, the disclosed techniques can result in intent-specific summarizations that are provided with less delay/latency (e.g., without having to wait for the end of an interaction to prompt an LLM). The disclosed techniques also allow for the generation of summaries in real-time, without waiting for the interaction to conclude to prompt a generative model with the entire interaction.

Thus, the disclosed techniques can improve the functioning of a computing system by avoiding adverse effects such as inaccuracies/hallucinations, latency, and lack of resiliency. Furthermore, the disclosed techniques are highly scalable in that the techniques can combine summaries for interaction spans classified with the same intent. In some embodiments, the disclosed techniques may generate an updated summary when a later classified intent is the same as an earlier classified intent. In these scenarios, the disclosed techniques may generate a prompt based on both of the corresponding interaction spans in order to reflect the full interaction relating to that intent.

The disclosed techniques include specific features other than what is well-understood, routine, conventional activity in the field, and add unconventional steps that demonstrate, in various embodiments, particular useful applications, such as, for example, predicting, by an intent shift classification model based at least in part on streaming data, a span of time over which a portion of a set of one or more digital interactions is associated with a single intent, and classifying that intent using an intent classification model and the portion of the set of digital interactions corresponding to that span.

Of course, it should be appreciated that the advantages and technical improvements described above and elsewhere herein are not the only advantages and/or technical improvements that may be realized because of the techniques described herein. Other advantages and/or technical improvements to the functioning of a computer itself or other technologies or technical fields may be apparent to one of ordinary skill in the art. Moreover, it will be appreciated that the disclosed techniques, while primarily described herein in the context of healthcare (e.g., health insurance), may instead apply to other types of industries, organizations, enterprises, etc.

### EXAMPLE COMPUTING SYSTEM

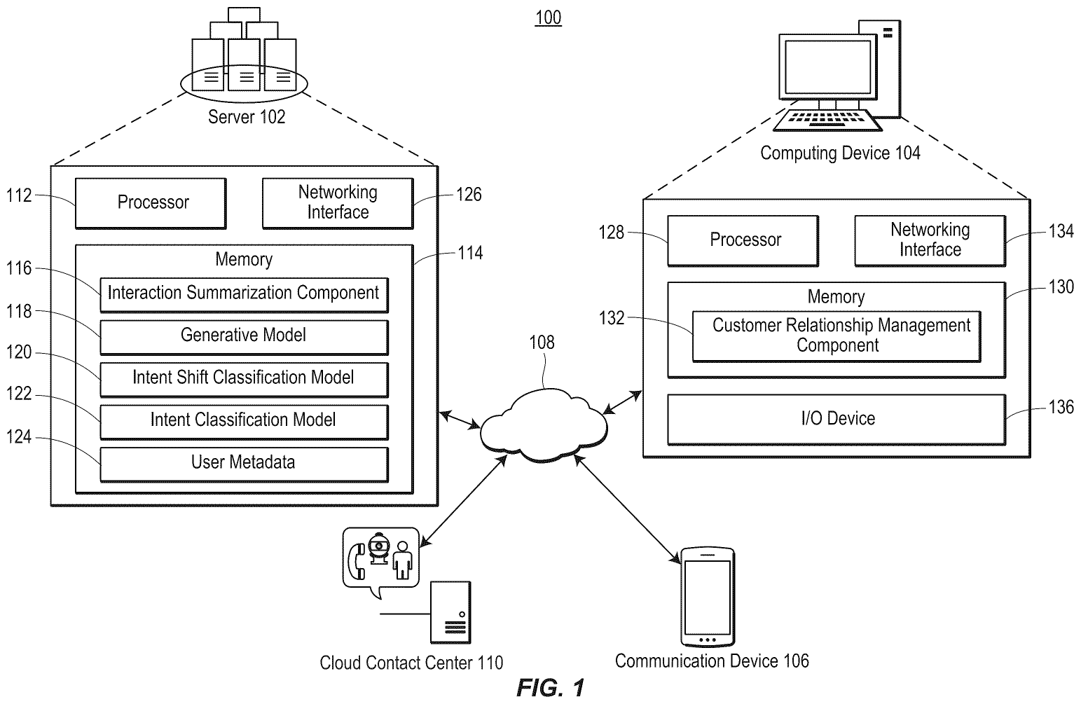

FIG. 1 depicts an example computing environment 100 in which various techniques and/or embodiments of the present disclosure can be implemented. The example computing environment 100 includes a server 102, a computing device 104, a communication device 106, and a cloud contact center 110. It should be appreciated that, while the server 102, computing device 104, communication device 106, and cloud contact center 110 are illustrated in FIG. 1 as single components, the example computing environment 100 may include multiple (e.g., dozens, hundreds, thousands) of servers 102, computing devices 104, communication devices 106, and/or cloud contact centers 110. In some embodiments the server 102, computing device 104, and cloud contact center 110 may be part of the same computing device and/or system.

The server 102 may be associated with an organization that operates, maintains, oversees, and/or services a call center, customer service center, contact center, support center, etc. and is generally configured to analyze and summarize device and/or channel interactions (e.g., interactions via text, audio, and/or other I/O channels) between users and devices and/or between first and second users. The computing device 104 may be associated with the same organization as server 102 and is generally configured to facilitate interactions between first and second users (e.g., between customers and representatives associated with the organization). The computing device 104 includes a processor 128, a memory 130, a networking interface 134, and an I/O device 136. The communication device 106 may be associated with a first user seeking to contact the organization associated with server 102 and/or computing device 104. The network 108 is generally configured to facilitate communication among and/or between the components of the example computing environment 100 and/or other components (e.g., via the Internet). The cloud contact center 110 is generally configured to provide an organization (e.g., the organization associated with server 102 and/or computing device 104) with contact center solutions (e.g., for text, audio, I/O interactions, and/or the like).

In some examples, the example computing environment 100 summarizes interactions by a server 102 accessing the interaction summarization component 116 (e.g., using an application programming interface (API)), and using classified intent(s) (e.g., topics, themes, matters, issues, subjects, etc.) and at least an interaction span to generate a first prompt.

Generating a summary of the interaction directed to the classified intent may include, for example, prompting a generative model 118 with the first prompt.

Generally, the server 102 summarizes device and/or channel interactions by performing certain operations on interactions (e.g., in real time as the interactions occur), as described in more detail below according to various embodiments. The server 102 may include only one server, or multiple servers that are co-located and/or remotely distributed. The server 102 may be part of a cloud network or may otherwise communicate with other hardware or software components within one or more cloud computing environments to send, retrieve, or otherwise analyze data and/or information described herein. In some example embodiments, the computing environment 100 comprises an on-premises computing environment, a multi-cloud computing environment, a public cloud computing environment, a private cloud computing environment, and/or a hybrid cloud computing environment. The server 102 includes a processor 112, a memory 114, and/or a networking interface 126. It should be appreciated that, while the server 102 is illustrated in FIG. 1 as a single component, the server 102 may include multiple (e.g., dozens, hundreds, thousands, etc.) of computing devices (e.g., servers) and/or other components.

The processor 112 includes any suitable number of processors and/or processor types. In some examples, the processor 112 includes one or more central processing units (CPUs), one or more graphics processing units (GPUs), one or more tensor processing units (TPUs), one or more field-programmable gate arrays (FPGAs), one or more application-specific integrated circuits (ASICs), and/or the like. Generally, the processor 112 comprises hardware configured to execute instructions (i.e., processor-executable code/instructions) stored in the memory 114.

The networking interface 126 comprises one or more hardware components that generally enable the server 102 to communicate via one or more network(s) (e.g., network 108) with other components and/or devices of the computing environment 100, such as the computing device 104, the communication device 106, the server 102 itself (e.g., between components of a server, between two or more servers within the server 102, etc.), and/or other suitable systems/devices or combinations thereof. More specifically, the networking interface 126 enables the server 102 to communicate with any component of the example computing environment 100 across the network 108. The networking interface 126 may comprise hardware and/or software that operates according to at least one communication protocol of the network 108.

The memory 114 includes any suitable memory type(s), including one or more volatile memories (e.g., dynamic and/or static random-access memory (RAM)) and/or non-volatile memories (e.g., read-only memory (ROM), erasable programmable ROM (EPROM), electrically EROM (EEROM), NAND flash, and/or solid state drive(s) (SSD(s))), all or any of which are examples of non-transitory computer-readable media. In some examples, the memory 114 stores one or more of: an operating system; one or more software components (e.g., firmware, application(s), binary, source code, executable instructions, transformer-based classification models, large language model(s)); transient data and/or code loaded and/or operated on by one or more software component(s); and/or other suitable components/data. In some examples, the memory 114 stores an interaction summarization component 116, a generative model 118, an intent shift classification model 120, an intent classification model 122, and/or user metadata 124, which are discussed further below. The memory 114 may additionally store other data, such as one or more other applications, databases, etc.

The interaction summarization component 116, when executed by the processor 112, generally performs one or more interaction summarization functions, such as receiving (or possibly generating) streaming data indicating a set of one or more digital interactions with a user (e.g., a member utilizing communication device 106), predicting, using an intent shift classification model 120 and streaming data, spans of time (e.g., representative of intent shifts such as shifts in the topic, theme, matter, issue, subject, etc., like the beginning of a new intent or the end of a current intent) over which portions of the digital interaction(s) are associated with particular intents, classifying, using an intent classification model 122 and portions of the digital interaction(s) corresponding to the spans of time, intents (e.g., labels/categories/etc. for the topics, themes, matters, issues, subjects, etc.) associated with the interaction portions, generating prompts based on the classified intents and the interaction portions/spans, and using a generative machine-learned model and the prompts to generate summaries that are specific to the classified intents. In some embodiments the interaction summarization component 116 is generally configured to access or otherwise use generative model 118, intent shift classification model 120, and/or intent classification model 122 to summarize interactions (or portions thereof) on an intent-by-intent basis.

The generative model 118 may be a transformer-based model trained to accept and analyze input text to generate output text. In some embodiments, the generative model 118 is a transformer-based machine-learned model (e.g., decoder-only or encoder-decoder architecture), such as an LLM, a multimodal model, and/or the like that operates upon and/or generates text along with one or more other types of content (e.g., images, video frames, and/or audio). The generative model 118 may comprise machine-learned model component(s), such as neural network(s), decision tree(s), and/or the like. The generative model 118 may receive a text prompt (referred to herein at times as simply a “prompt”) as an input, process the text prompt, and output text content responsive to the text prompt. The generative model 118 may perform various natural language processing tasks as needed to understand a text query/prompt and generate a response to the text query/prompt. In some embodiments, the generative model 118 performs one or more pre-processing operations and/or post-processing operations. For example, in a pre-processing operation the generative model 118 may augment the original prompt to add sufficient context (e.g., context based on processing inputs determined from user data, a variety of intents, and/or the like) associated with the prompt. In a post-processing operation, the generative model 118 may review and alter (e.g., self-refinement), as necessary, an output of the same and/or a different transformer-based machine-learned model.

In embodiments with a transformer-based model architecture, the generative model 118 may comprise an encoder that tokenizes the input and determines embeddings for the tokens, and a decoder that generates the output based at least in part on the embeddings. The generative model 118 may incorporate self-attention, cross-attention, and/or any suitable self-attention or attention mechanisms to facilitate more accurate output. In some embodiments, the generative model 118 may include different configurations of self-and/or cross-attention, followed by one or more neural networks (e.g., feedforward layer(s)), recurrent layer(s), aggregation layer(s) (e.g., using SoftMax, matrix multiplication, and/or other aggregation techniques), and/or the like. The generative model 118 may be a general-purpose model (e.g., trained on a wide array of publicly available datasets such as web pages, documents, etc., available via the Internet), such as bi-directional encoder representations from transformers (BERT), bidirectional and auto-regressive transformers (BART), text-to-text transfer transformer (T5), generative pre-trained transformer (GPT) 3.5, efficiently learning an encoder that classifies token replacements accurately (ELECTRA), conditional transformer language model (CTRL), generalized autoregressive pretraining for language understanding (XLNet), or a domain-specific model (e.g., trained and/or fine-tuned on custom and/or proprietary datasets), for example. The generative model 118 may be trained by any suitable method (e.g., pre-training, fine-tuning, reinforcement learning from human feedback (RLHF), transfer learning, zero/few/one-shot learning, etc.) using user interactions, interaction spans, intents, etc. to generate summaries.

In some embodiments, the intent shift classification model 120 and intent classification model 122 are transformer-based models (e.g., similar to generative model 118 as discussed above). In other embodiments, the intent shift classification model 120 and/or intent classification model 122 may include non-transformer-based methods/models such as TextRank, Latent Semantic Analysis (LSA), Hidden Markov Models (HMM), Support Vector Machines (SVM), clustering, recurrent neural networks (RNN), Convolutional neural networks (CNN), naïve bayes, etc.

It should be understood that the generative model 118, intent shift classification model 120, and/or intent classification model 122 may be locally stored in the server 102 using memory 114 and/or may be cloud based (e.g., hosted by OpenAI®), and accessed via an API or the like. It should be appreciated that some embodiments may include combinations of the foregoing such as using locally hosted generative model 118 in some scenarios and a different cloud-based generative model for other scenarios (i.e., for privacy reasons, computational efficiency, to optimize costs, etc.).

The user metadata 124 may include data and/or information associated with the user (e.g., a member, customer, patron, subscriber, client, guest, etc.), such as information that an organization might store and/or collect in the ordinary course of business (e.g., name, address, date of birth, policy number, plan type, coverage details, claims history, payment history, provider network, customer service interactions, etc.). In certain embodiments, the data and/or information associated with the user is or includes a set of such text strings, files, documents, and/or any other suitable data/datatype(s) or combinations thereof. While depicted in FIG. 1 as being stored within the memory 114 of the server 102, the user metadata 124 may instead also be stored elsewhere in the example computing environment 100 and/or at any other suitable location using any suitable techniques (e.g., at on-premises servers, cloud storage services, customer relationship management systems, data warehouses, enterprise resource planning systems, etc.).

The interaction summarization component 116 and/or the customer relationship management component 132 may use the user metadata 124 (e.g., in a prompt for the generative model 118) to improve the accuracy of summaries. In some embodiments the generative model 118 itself, or a different generative model, may extract a relevant portion of user metadata (e.g., a user's name, phone number, policy number, etc.) from the larger set of user metadata (e.g., all the metadata associated with a user, all user metadata related to a presently classified intent, all user metadata related to a previously classified intent, etc.). The generative model 118 may extract the relevant user metadata based on at least the interaction span and/or the classified intent. For example, for a classified intent of “send informative email”, the generative model 118 may extract the user's email address from the larger set of user metadata, and the interaction summarization component 116 may pre-populate the user's email address when generating the prompt for the generative model 118 to summarize the interaction. In other embodiments a user (e.g., a second user associated with computing device 104) may select the relevant portion of the user metadata 124 from a larger set of user metadata via the customer relationship management component 132.

In some embodiments, the computing device 104 includes a computer (e.g., desktop computer, laptop computer, terminal), a mobile device, a wearable, augmented reality glasses/headsets, virtual reality glasses/headsets, mixed or extended reality glasses/headsets, and/or other suitable computing device(s). The computing device 104 includes a processor 128 (e.g., similar to the processor 112) and a memory 130 (e.g., similar to the memory 114) for storing and executing one or more software components, computer-executable instructions, etc. The computing device 104 may further include a networking interface 134 (e.g., which may be the same as or similar to the networking interface 126) and an I/O device 136 (e.g., a display, such as a monitor; a user input device, such as a keyboard, mouse, trackpad, gesture and/or biometric tracking device, or the like). The computing device 104 may access services, devices, and/or components of the computing environment 100 via the network 108. In some embodiments, the computing device 104 transmits and/or receives (e.g., to and/or from the server 102 and/or the cloud contact center 110) data and/or information associated with the interaction summarization techniques described herein (e.g., one or more classified intents, one or more interaction spans, an entire interaction, one or more summaries, user metadata, etc.). It should be appreciated that, while computing device 104 is illustrated in FIG. 1 as a single component, the computing device 104 may include multiple components/devices.

The customer relationship management component 132 generally manages interactions between users and second users. The customer relationship management component 132 may provide a centralized platform with a user interface (UI) enabling a second user (e.g., an organizational representative) to provide personalized and efficient service. The customer relationship management component 132 may be an application developed and/or managed by a third-party CRM software provider (e.g., Salesforce®, HubSpot®, Microsoft Dynamics 365®, Zoho CRM, Pipedrive®, etc.). The customer relationship management component 132, when executed by the processor 128, generally performs one or more device and/or channel interaction summarization functions, such as receiving, user revisions of intents, receiving user selections of user metadata, receiving interaction summaries for display to second users, receiving user revisions of interaction summaries, etc.

The customer relationship management component 132 may receive automated and/or user selected portions of user metadata 124 to generate prompts for accurate summaries. For example, by integrating the user metadata 124 into the summarization techniques described herein, the generative model 118 may ensure that existing information from the interaction is accurate (i.e., matches the user metadata 124). By utilizing the user metadata 124 the present techniques allow for the generative model 118 to use trusted/authoritative data and/or information to remedy any discrepancies that may arise from mistranscriptions (e.g., part of the members policy number may transcribe as “14” instead of “40” and the generative model 118 uses the authoritative members policy number from the user metadata 124 when generating a summary), and/or to further reduce the likelihood that the generative model 118 will hallucinate or otherwise provide inaccurate summaries (e.g., output a summary reflecting an intent that cannot possibly be the intent of a user associated with a particular gender, location, etc.). The customer relationship management component 132 may utilize interaction identifiers and intent identifiers to avoid ambiguity where there may be a one-to-one (e.g., one interaction with one intent discussed), one-to many (e.g., a multi-intent interaction with one interaction and many intents), and/or many-to-many relationship (e.g., multiple multi-intent interactions with multiple interactions and multiple intents).

The communication device 106 generally facilitates interaction/communication between device users (e.g., via text, audio, and/or other I/O channels, such as by typing, clicking, tapping, gesturing, etc.) between individuals (e.g., customers) and an organization (e.g., one that operates, maintains, oversees, and/or services a call center, customer service center, contact center, support center, etc.). The communication device 106 may be a smartphone, a tablet, a laptop, a desktop computer, a smart speaker, a smart watch, etc. of customer or potential customer, for example. It should be appreciated that, while communication device 106, is illustrated in FIG. 1 as a single component, the communication device 106 may include multiple (e.g., dozens, hundreds, thousands) component/devices. In some embodiments, for example, the communication device 106 includes one or more of the foregoing components/devices in combination, such as smartphone tablet combination (e.g., a phablet) or a tablet laptop combination (e.g., a 2-in-1 tablet laptop), etc.

The network 108 includes wired and/or wireless communication network(s) such as a cellular network (e.g., 5G®, 4G LTE®, 3G®), a Wi-Fi® network (802.11 standards), a microwave access network (e.g., WiMAX®), and/or any other suitable wide area network (WAN), local area network (LAN), personal area network (PAN), etc. Moreover, the network 108 may be a single communication network, or may include multiple communication networks of one or more types (e.g., one or more wired and/or PANs or LANs, and/or one or more WANs such as the Internet). In some embodiments, the network 108 includes multiple, entirely distinct networks (e.g., one or more networks for communications between server 102 and computing device 104, and a separate, Bluetooth® or wireless LAN (WLAN) network for communications between server 102 and computing device 104, and so on). It should be appreciated that, while the network 108 is illustrated in FIG. 1 as a single component, the network 108 may include multiple (e.g., dozens, hundreds, thousands) networks 108.

The cloud contact center 110 generally provides an enterprise with contact center solutions by facilitating interactions with communication devices such as communication device 106. The cloud contact center 110 may be a cloud-based, omnichannel contact center solution (e.g., an omni Genesys® call platform, Five9®, Amazon Connect®, Avaya® OneCloud CCaas, Talkdesk®, NICE inContact CXone®, Twilio Flex®, etc.). The cloud contact center 110 (e.g., omni Genesys® call platform) may integrate a voice analytics platform (VAP) and an event hub to enable real-time, granular (e.g., utterance level, sentence level, word level, phoneme level, etc.) transcription of audio interactions by means of suitable automated speech recognition (ASR) software (e.g., Azure® STT, Google® Cloud Speech-to-Text, Amazon® Transcribe, IBM Watson® Speech to Text, Deepgram®, AssemblyAI, Rev.ai, etc.). It should be appreciated that, while the cloud contact center 110, is illustrated in FIG. 1 as a single component, the cloud contact center 110 may include multiple (e.g., dozens, hundreds, thousands) components/devices. In some embodiments, the computing environment 100 excludes the cloud contact center 110 (e.g., if the server 102 or computing device 104 facilitates interactions with users).

### EXAMPLE INTENT-SPECIFIC SUMMARIZATION FLOWS

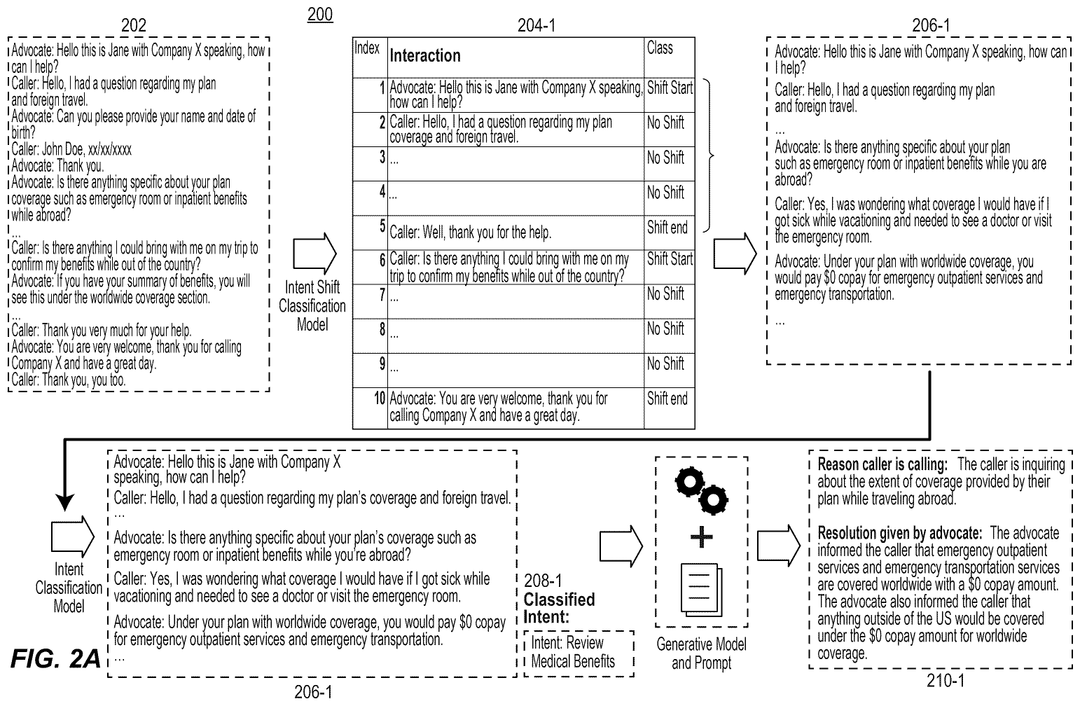

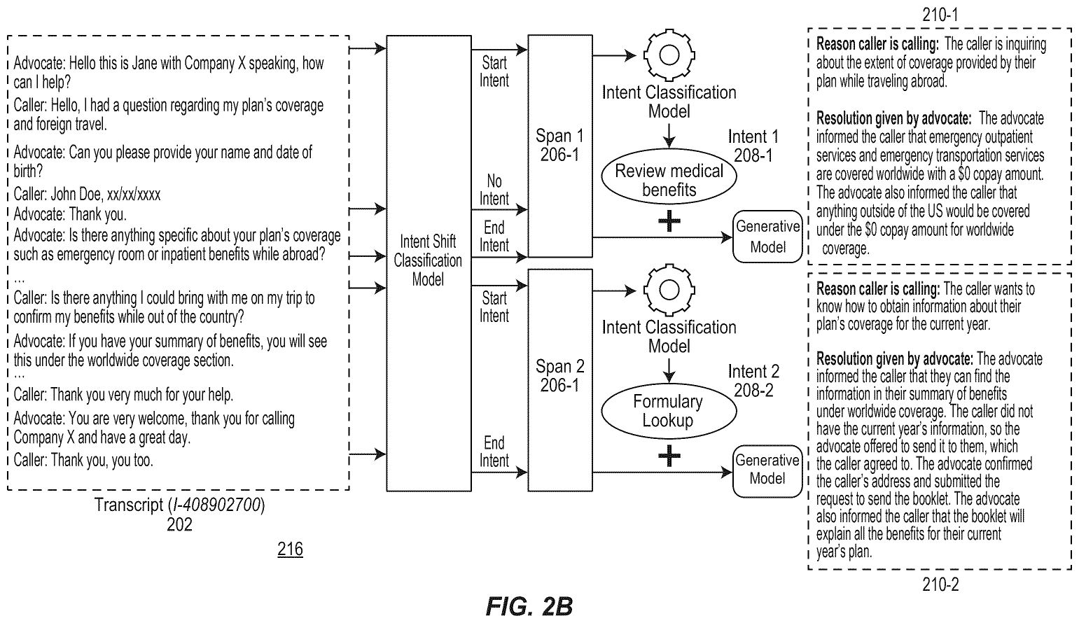

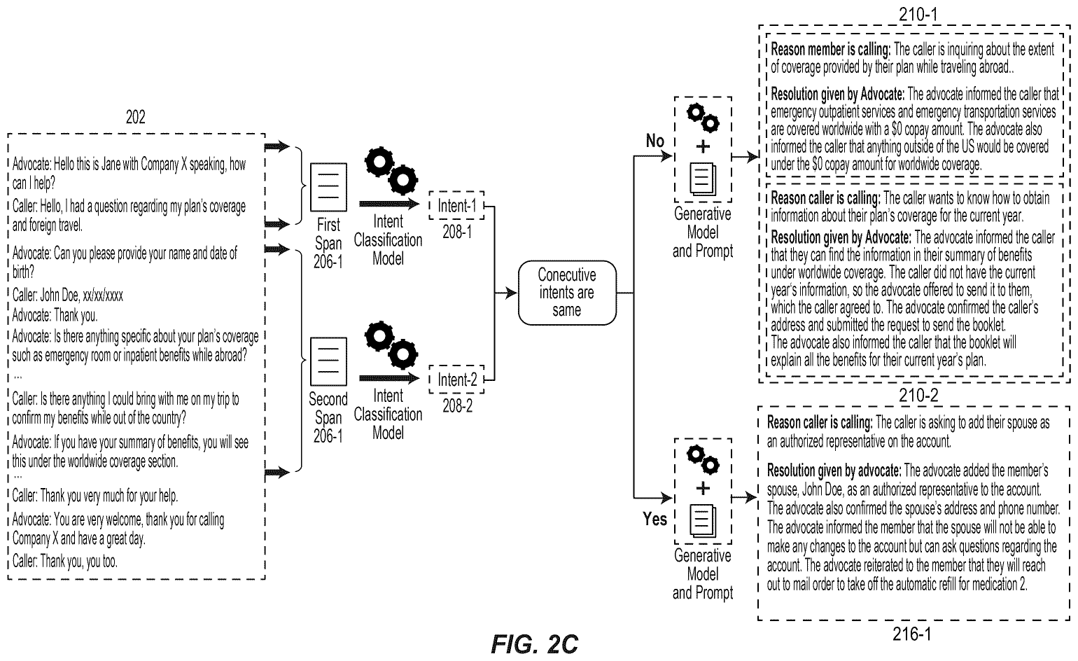

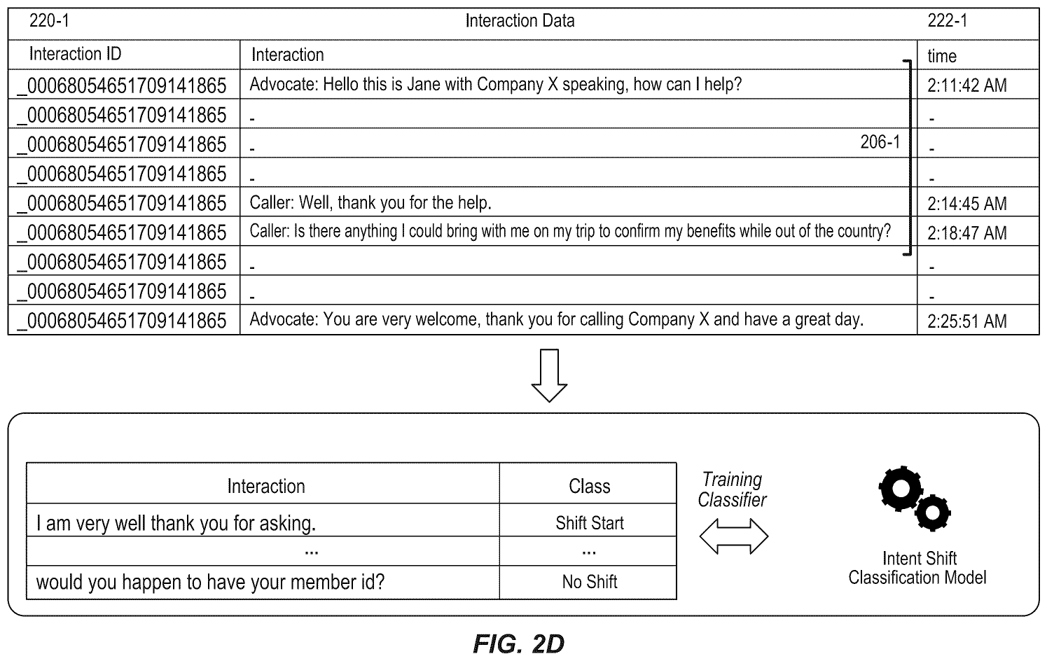

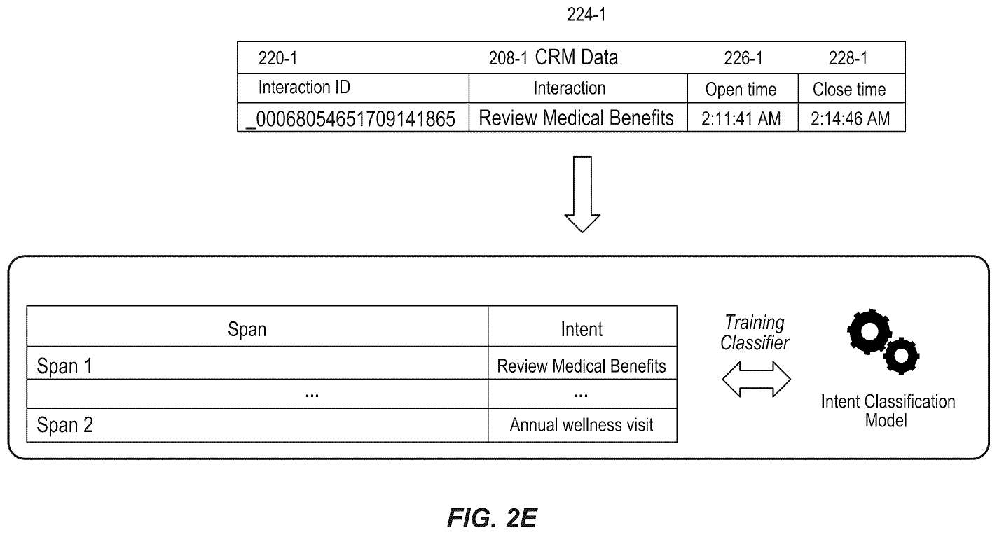

FIG. 2A depicts an example intent-specific device and/or channel interaction summarization flow 200, in accordance with various embodiments described herein. The summarization flow 200 broadly illustrates the actions performed by components, devices, and/or systems (e.g., the server 102, the interaction summarization component 116, the generative model 118, the intent shift classification model 120, the intent classification model 122, the computing device 104, and/or the customer relationship management component 132, etc.) of the computing environment 100, in one example embodiment and scenario.

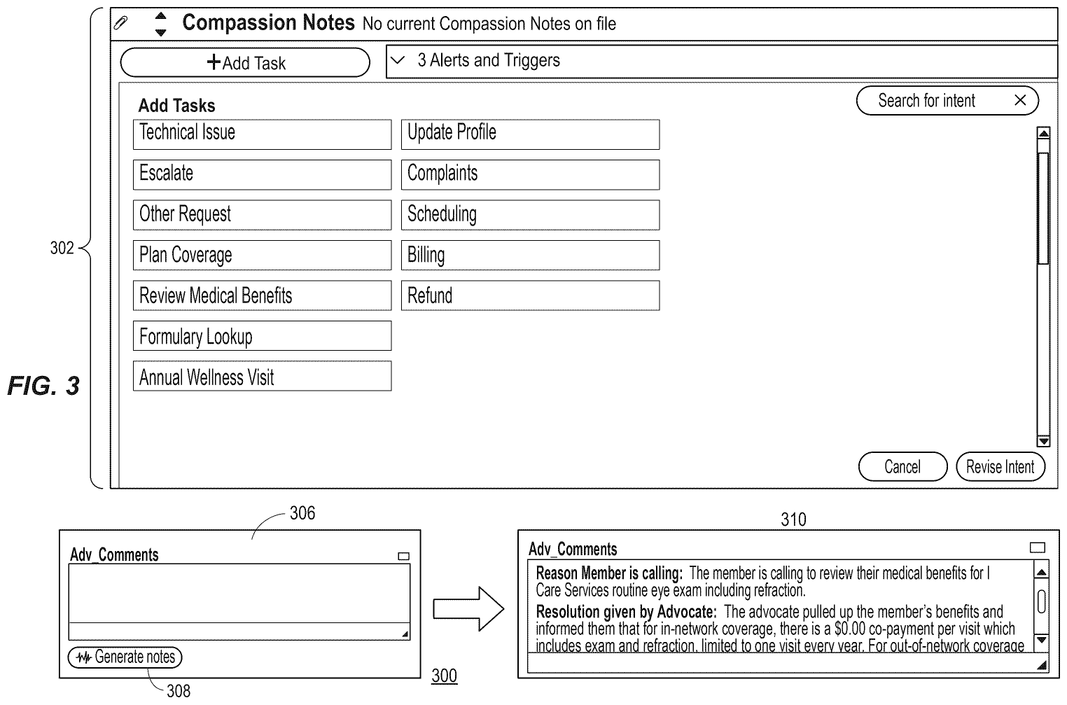

The summarization flow 200 may begin with a first user (e.g., a customer utilizing communication device 106) contacting an organization (e.g., via the cloud contact center 110). The first user (the “Caller” of FIGS. 2A-2E and 3) may receive assistance from a second user associated with the organization (the “Advocate” of FIGS. 2A-2E and 3) utilizing the customer relationship management component 132. The first user may be, for example, an individual contacting the organization in his or her personal capacity, or a user (e.g., member, patron, client, user, buyer, consumer, devotee, follower, supporter, visitor, etc.) of an organization seeking to contact the organization, etc. The first user may contact the organization using any suitable means (e.g., phone call, video call, online chat/messaging platforms, voice over Internet protocol (VoIP) services, applications specifically designed for customer service, etc.). The second user may be, for example, any suitable user associated with an organization (e.g., a health insurance company), such as a customer service agent, support specialist, help desk agent, account manager, customer experience associate, relationship manager, call center ambassador, client care coordinator, technical support representative, service helpline agent, etc.

During the interaction, the cloud contact center 110 may receive streaming data indicating a set of digital interactions 202 (e.g., in real time). The set of digital interactions 202 may be a transcript, record, data, documentation, etc. of the contact between the first user and the second user (e.g., to resolve one or more problems and/or questions). In some embodiments, cloud contact center 110 generates a transcript of the set of digital interactions 202 in real-time as the interaction occurs, such that the set of digital interactions 202 builds/expands throughout the interaction. For case of explanation, the following description of FIGS. 2A-2E refers to embodiments in which the set of digital interactions 202 is generated by cloud contact center 110 (e.g., in real-time as the interaction occurs).

The interaction summarization component 116 may receive streaming data indicating a set of digital interactions 202 from the cloud contact center 110 (e.g., periodically as a transcript is generated). Streaming data may include real-time data (e.g., audio data, video data, textual/transcript data, I/O data, etc., as the first and second users generate that data via their respective devices). As the interaction occurs, the interaction summarization component 116 may use intent shift classification model 120 to classify portions of the set of digital interactions (e.g., interaction portion 204-1 on an utterance-by-utterance basis). In some embodiments, the intent shift classification model 120 classifies part (e.g., each word, utterance, sentence, gesture, etc.) of the interaction portion 204-1 as one of: shift start (e.g., indicating the beginning of an intent), shift end (e.g., indicating the resolution of an intent), or no shift (e.g., indicating neither the beginning nor the resolution of an intent). In other embodiments, there may be any other suitable number of intent shift classes (i.e., only two, or more than three) that the intent shift classification model 120 is trained to predict, determine, output, etc. As depicted in FIG. 2A, each utterance of the interaction portion 204-1 may have an associated index (e.g., in chronological sequence) and intent shift class. The interaction summarization component 116 may predict a span of time over which the interaction portion 204-1 is associated with a first intent. The span of time may be defined by shifts (e.g., a change in topic, a new question, a resolution of an intent, etc.) when the interaction portion 204-1 includes utterances with a classified shift start and classified shift end. The interaction summarization component 116 may extract (e.g., concatenate, append, combine, join, merge, etc.) part (e.g., utterances) of the interaction portion 204-1 between a classified shift start (e.g., “How can I help?”) and classified shift end (e.g., “Well, thank you for the help.”) into an interaction span 206-1. The interaction summarization component 116 may use an intent classification model 122 to classify the interaction span 206-1 as at least one intent 208-1 (e.g., “Review Medical Benefits”). The classified intent 208-1 may be from a set of predefined intents, such as those discussed below in the example of FIG. 3. After classifying an intent 208-1, the interaction summarization component 116 may generate (e.g., format, package, etc.) a prompt for a summary 210-1 using the interaction span 206-1 and classified intent 208-1. The interaction summarization component 116 may then use the generative model 118 and the generated prompt to generate/output a summary 210-1. The summary 210-1 may generally be an overview of the interaction span 206-1 corresponding to the classified intent 208-1. The interaction summarization component 116 may then send the summary 210-1 corresponding to the interaction span 206-1 and classified intent 208-1 to the customer relationship management component 132 for the second user to review and save (e.g., to a database for storing customer interactions).

In some embodiments, the interaction span 206-1 may be inclusive of the part of the interaction classified as a shift start and shift end (i.e., the interaction summarization component 116 extracting the utterances of the interaction portion 204-1 includes the utterances classified as shift start and shift end). In other embodiments, the interaction span 206-1 may be exclusive (i.e., include neither) of the part of the interaction classified as shift start and/or shift end. In further embodiments, the extraction may include one of the part of the interaction classified as a shift start or shift end and exclude the other.

Generally, in some embodiments, the intent shift classification model 120 classifies part of the interaction as a shift start based on language, gestures, symbols, expressions, etc. typically understood to be associated with the beginning of an intent (e.g., in the example of FIG. 2A, “How can I help you?” and “Is there anything I would have in my possession that would provide this information that I could bring with me?”), and classifies part of the interaction as a shift end based on language typically understood to be associated with the end of an intent (e.g., in the example of FIG. 2A, “Well, thank you for the help.” and “Thank you for calling and I hope you have a good rest of your day.”). The intent shift classification model 120 classifies all other parts of the interaction that are not associated with the beginning or end of an intent as no shift (e.g., utterances directed to resolving the intent of the first user).

The intent classification model 122 generally classifies interaction span 206-1 based at least in part on context, keywords, phrases, patterns, etc., contained therein and indicative of the first user's intent (e.g., using contextualized word embeddings, relationships between words captured by the attention mechanism, positional information, subword tokenization, implicit syntactic and semantic information, world knowledge, task-specific features, and/or other suitable techniques). The classified intent 208-1 helps to ensure that the summary 210-1 is not only relevant but also contextually rich, advantageously enhancing the utility of the documentation for subsequent review or action, and thereby improving the efficiency and effectiveness of interaction handling and documentation.

In some embodiments, the intent shift classification model 120 may additionally consider the speaker (e.g., whether the first user or the second user is speaking) when classifying the interaction portion 204-1 as including an intent shift (e.g., with the shift classification model having been trained using an identifier of the speaker type as an additional input/feature).

In some embodiments, the second user may (e.g., after reviewing the summary 210-1 and determining that the classified intent is wrong) use the customer relationship management component 132 to select a revised intent classification (i.e., different than the classified intent 208-1) from a set of predefined intents (e.g., the intents discussed further in the example of FIG. 3). In some of these embodiments, the customer relationship management component 132 sends the revised intent to the interaction summarization component 116, which generates a revised prompt using the revised intent and the interaction span 206-1. The interaction summarization component 116 may then input the revised prompt into the generative model 118 to generate/output a revised/updated summary. The interaction summarization component 116 may then send the updated summary corresponding to the interaction span 206-1 and revised intent back to the customer relationship management component 132 for the second user to review and save. By allowing for revision of the intent, the summarization flow 200 can further ensure that the saved summary accurately reflects the interaction and intents of the first user.

In an alternative embodiment, cloud contact center 110 (or server 102, etc.) generates a transcript of the set of digital interactions 202 after the interaction is complete. In some embodiments, cloud contact center 110 (rather than server 102) extracts interaction spans such as interaction span 206-1 based on predicted time spans (e.g., including an intent shift). In these embodiments, the interaction summarization component 116 may receive from the cloud contact center 110 the interaction span 206-1.

FIG. 2B depicts an example summarization flow 212 for summarizing multi-intent interactions. Substantially as before with summarization flow 200, a summary 210-1 may be generated by generative model 118 based on an interaction span 206-1 and classified first intent 208-1. The summarization flow 212 may further include the interaction summarization component 116 using the intent shift classification model 120 to classify beginning and ending parts of the interaction of a second interaction portion 204-2 (not depicted) as a shift start and shift end, respectively. The interaction summarization component 116 may extract the part of the interaction of the second interaction portion 204-2 between the classified shift start (e.g., “Is there anything I would have in my possession that would provide this information that I could bring with me?”) and classified shift end (e.g., “Thank you very much for your help.”) into an interaction span 206-2. The interaction summarization component 116 may use an intent classification model 122 to classify the interaction span 206-2 as at least one intent 208-2 (e.g., “Formulary lookup”). After classifying an intent 208-2, the interaction summarization component 116 may generate a prompt for a summary 210-2 using the interaction span 206-2 and classified intent 208-2. The interaction summarization component 116 may then input the generated prompt into the generative model 118 to generate/output a summary 210-2. The interaction summarization component 116 may then send the summary 210-2 corresponding to the interaction span 206-2 and classified intent 208-2 to the customer relationship management component 132 for the second user to review and save. In some embodiments and/or scenarios, the summarization flow 212 may continue as described above for the second intent for any suitable number of additional intents.

In some non-depicted embodiments the interaction span 206-1, 206-2, etc. is not limited by the classified intent shifts but may include a plurality of interaction spans (e.g., an interaction span 206-3 between the first and third classified intent shifts, an interaction span 206-5 between the beginning of the interaction and the fifth classified intent shift, an interaction span 206-12 between the eighth classified intent shift and the end of the interaction, etc.).

FIG. 2C depicts an example intent-specific interaction summarization flow 214, for generating an updated summary 216-1 based on a previously classified intent 208-1 matching a presently classified intent 208-2. As before with summarization flow 212, a summary 210-1 may be generated by generative model 118 based on an interaction span 206-1 and classified first intent 208-1. The summarization flow 214 may further include the interaction summarization component 116 using intent shift classification model 120 to classify beginning and ending parts of the interaction of a second interaction portion 204-2 (not depicted) as a shift start and shift end. The interaction summarization component 116 may extract the part of the interaction of the second interaction portion 204-2 between the classified shift start (e.g., “Is there anything I would have in my possession that would provide this information that I could bring with me?”) and classified shift end (e.g., “Thank you very much for your help.”) into an interaction span 206-2. The interaction summarization component 116 may use the intent classification model 122 to classify the interaction span 206-2 as at least one intent 208-2 (e.g., “Formulary lookup”). After classifying an intent 208-2, the interaction summarization component 116 may determine whether a previously classified intent 208-1 is identical to the classified intent 208-2. If the presently classified intent 208-2 does not match a previously classified intent 208-1, the summarization process continues as with summarization flow 212 (i.e., generating a different summary 210-2). If the presently classified intent 208-2 matches a previously classified intent 208-1, an updated summary 216-1 may be generated. The interaction summarization component 116 may generate a prompt for an updated summary 216-1 using the interaction span 206-1, interaction span 206-2, and classified intent 208-1. The interaction summarization component 116 may then input the generated prompt into the generative model 118 to generate/output an updated summary 216-1. The interaction summarization component 116 may then send the updated summary 216-1 corresponding to the interaction span 206-1, interaction span 206-2, and classified intent 208-1 to the customer relationship management component 132 for the second user to review and save. In some embodiments and/or scenarios, the summarization flow 214 may continue as described above for the updated summary 216-1 for any suitable number of additional updated summaries 216-2, 216-3, etc. The updated summary 216-1 advantageously ensures thorough and accurate documentation eliminating duplicative summaries, thereby saving storage space, streamlining the review process for second users and other stakeholders (e.g., compliance teams reviewing transcripts), increasing operational efficiency, and ensuring data management best practices.

It should be understood that the summarization flow 214 is not limited to consecutively classified intents but may include an updated summary 216-1 for a first classified intent 208-1 and a third classified intent 208-3, for example. That is an updated summary 216-1 may be generated for intents classified at any point throughout an interaction.

In some embodiments, the summarization flow 200, 212, and/or 214 may incorporate CRM metadata (i.e., additional data and/or information) into the summarization process. As or after the second user resolves an intent of the first user, in these embodiments, the second user can also select additional data and/or information about the first user (e.g., the first user's plan number) for use in preparing one or more intent summaries. In some embodiments the second user selects a portion of user metadata 124 (e.g., the second user may select a portion of all available metadata associated with the first user). In other embodiments the second user selects from a subset of user metadata 124 (e.g., only the metadata associated with the first user that is relevant to the classified intent, and/or a previously classified intent, etc.). The customer relationship management component 132 may send the selected additional data and/or information to the interaction summarization component 116 with CRM data 224-1, which may be packaged into a suitable filetype, for example. In these embodiments, the interaction summarization component 116 may generate the generative model prompt discussed above for a summary 210-1 using not only the interaction span 206-1 and classified intent 208-1, but also the selected CRM metadata. The use of CRM metadata advantageously enriches the prompt with authoritative data to help ensure summaries are accurate, including circumventing issues that may arise due to mistranscription and/or generative model hallucination.

The summarization flow 200, 212, and/or 214 may include any suitable number of classified intents with any suitable number of CRM metadata selections. The CRM metadata selections may be the same or may differ based on the classified intent 208-1, 208-2, etc. In some non-depicted embodiments, generative model 118, or another generative model, when prompted with the classified intent 208-1, 208-2, etc. may generate the respective CRM metadata by extracting a relevant portion of user metadata 124 (e.g., using retrieval augmented generation).

In some embodiments, after resolving the first intent, the second user may use a user interface text input (e.g., virtual text box, microphone with a speech-to-text tool, etc.) to provide additional context via second user comments (e.g., “The member does not want to be on auto refill and member has been removed from auto refill.”) that the second user thinks may not be readily enough apparent from the set of digital interactions 202, interaction portion 204-1, interaction span 206-1, classified intent 208-1, and/or CRM metadata. The second user may select one or more user interface controls/inputs serving as a submit button. The customer relationship management component 132 may send the second user comments to the interaction summarization component 116 with CRM data 224-1, which may be packaged into a suitable filetype, for example. In these embodiments, the interaction summarization component 116 may generate the generative model prompt discussed above for a summary 210-1 using not only the interaction span 206-1 and classified intent 208-1, but also the second user comments. The interaction summarization component 116 may then send the summary 210-1 corresponding to the interaction span 206-1, classified intent 208-1, and second user comments to the customer relationship management component 132 for the second user to review and save. The use of second user comments advantageously enriches the prompt with data representing an additional, human perspective, to help ensure summaries are accurate, including circumventing issues that may arise due to mistranscription and/or generative model hallucination.

In some embodiments and/or scenarios, the summarization flow 200, 212, and/or 214 may further include any suitable number of classified intents with any suitable number of second user comments. As with the CRM metadata selections, the second user comments may be the same or different (e.g., depending on the classified intent).

In some embodiments and/or scenarios, the interaction summarization component 116 may delay (e.g., a few seconds, until the next classified intent shift, etc.) generating a prompt to ensure the second user has ample time to add second user comments, select CRM metadata, etc. In other non-depicted scenarios where the second user adds second user comments, selects CRM metadata, etc. after a summary 210-1 is generated, the interaction summarization component 116 may generate a refined prompt including the summary 210-1 and the second user comments, CRM metadata, etc. The interaction summarization component 116 may input the refined prompt into the generative model 118 to generate/output a refined interaction summary corresponding to the added information (e.g., second user comments, CRM metadata, etc.). The interaction summarization component 116 may send the refined interaction summary to the customer relationship management component 132 for the second user to review again and save.

In some embodiments, the summarization flow 200, 212 and/or 214 may also summarize an entire interaction. For example, at the end of the interaction, after classifying all the intents of the set of digital interactions 202, the interaction summarization component 116 may generate a prompt for an entire interaction summary using the set of digital interactions 202 and optionally at least one of the classified intents 208-1, 208-2, etc., CRM metadata and/or second user comments. The interaction summarization component 116 may input the generated prompt into the generative model 118 to generate/output an entire interaction summary. The interaction summarization component 116 may send the entire interaction summary to the customer relationship management component 132 for the second user to review and save.

In still other embodiments, the summarization flow 200, 212, and/or 214 may generate the prompt for generative model 118 using a generative model (e.g., generative model 118 or a different generative model) or may use a pre-generated prompt template (e.g., selected from a set of predefined prompt templates corresponding to respective intents from the predefined set of intents) when generating summary 210-1 and/or summary 210-2. For example, a generated or pre-generated prompt may include/be prompted by the interaction span 206-1, 206-2, etc. classified intent 208-1, 208-2, etc. and optionally CRM metadata, second user comments, and/or a revised intent.

FIGS. 2D and 2E depict example interaction data 218-1 and example CRM data 224-1. The interaction data 218-1 and CRM data 224-1 broadly illustrate data and/or information that may inform actions performed by components, devices, and/or systems (e.g., the server 102, the interaction summarization component 116, the generative model 118, the intent shift classification model 120, the intent classification model 122, the computing device 104, and/or the customer relationship management component 132, etc.) of the computing environment 100. The interaction data 218-1 may include the interaction span 206-1, an interaction ID 220-1, and a timestamp 222-1. The CRM data 224-1 may include the intent 208-1, the interaction ID 220-1, an open time 226-1, and a close time 238-1. The interaction ID 220-1 may be a unique identifier for associating a particular interaction with, among other things, particular interaction spans 206-1, 206-2, etc., intents 208-1, 208-2, etc., open times 226-1, 226-2, etc., close times 228-1, 228-2, etc. The timestamp 222-1 may be generated by the cloud contact center 110 corresponding to when an interaction begins. When predicting a span, the timestamp 222-1 of an interaction (e.g., “How can I help?”) classified as shift start (e.g., by the intent shift classification model) may define an open time 226-1 (e.g., the beginning) of the interaction span 206-1. Further, the timestamp 222-1 of an utterance (e.g., “Well, thank you for the help.”) classified as a shift end may define a close time 228-1 (e.g., the end) of the interaction span 206-1. Thus, the interaction between (e.g., inclusive of) an open time 226-1 and a close time 228-1 may define the interaction span 206-1. The interaction span 206-1 may be classified (e.g., by the intent classification model) as an intent 208-1 (e.g., “Review Medical Benefits”). Thus, the CRM data 224-1 may associate an interaction ID 220-1 with a classified intent 208-1 and the open time 226-1 and close time 228-1 defining the interaction span 206-1.

In some embodiments, ground truth labels for training (e.g., supervised learning) the intent shift classification model 120 and/or the intent classification model 122 may be generated based on the second user's interaction with the customer relationship management dashboard 300, discussed below (and/or based on similar interactions from other users). For example, the second user's service interaction data indicating interaction with a hosted service may be used to determine a span of time over which a portion of the set of digital interactions is deemed to be associated with a particular intent classification. The timestamped elements (e.g., utterances) of the interaction, paired with this service interaction data that records the second user's actions during the interaction, may then be used to generate data-labels pairs for training (e.g., finetuning) the intent shift classification model 120 and/or the intent classification model 122. For example, the approximate duration that a particular workflow is open in the customer relationship management dashboard 300 may be used as a proxy for when the corresponding utterances or other elements of the digital interaction(s) relate to a particular intent that corresponds to the open workflow. Additionally or alternatively, the time when the second user opens or closes a workflow in the customer relationship management dashboard 300 may be used as a proxy for when an intent shift occurs. Ground truths/labels generated in this manner can advantageously improve the accuracy and reliability of the classification models 120 and/or 122.

Additionally or alternatively, in some embodiments, the service interaction data indicating interaction with a hosted service may be used when predicting the span of time over which a portion of the set of digital interactions is associated with a first intent. Similarly, the service interaction data may be used when classifying the intent classification associated with the portion of the set of digital interactions.

In some embodiments, the interaction ID(s) and intent(s) may have a one-to-one (e.g., one interaction with one intent discussed), one-to many (e.g., a multi-intent interaction with one interaction and many intents), and/or many-to-many relationship (e.g., multiple multi-intent interactions with multiple interactions and multiple intents). In some non-depicted embodiments, the CRM data 224-1 may include second user comments and/or CRM metadata, discussed below.

It should be understood that in various embodiments and/or scenarios, there may be any suitable number (e.g., 1, 2, 3, 4, 5, etc.) of interaction portions 204-1, 204-2, 204-3, etc., interaction spans 206-1, 206-2, 206-3, etc., classified intents 208-1, 208-2, 208-3, etc., summaries 210-1, 210-2, 210-3, etc., and/or updated summaries 216-1, 216-2, 216-3, etc., which may represent one or more iterations, repetitions, cycles, etc. of the summarization flow 200, 212, and/or 214 (or a portion thereof). Further it should be understood that the depicted summarization flows 200, 212, and/or 214 are not an exhaustive list of possibilities and may include additional, fewer, and/or alternative actions, components, devices, and/or systems.

### EXAMPLE CUSTOMER RELATIONSHIP MANAGEMENT DASHBOARD

FIG. 3 depicts an example customer relationship management dashboard 300. The customer relationship management dashboard 300 illustrates an example UI implemented by components and devices (e.g., the customer relationship management component 132, the computing device 104, etc.) of the computing environment 100. The customer relationship management dashboard 300 may include one or more user interface controls/inputs (e.g., graphical user interface (GUI) icons, virtual buttons, virtual text boxes, etc.) such as a set of predefined intents 302, a revise intent button 304, a second user comments text box 306, a submit button 308, and/or an editable summary text box 310. The customer relationship management component 132 may be accessed by a second user interacting with the customer relationship management dashboard 300. It should be understood that additional/alternative CRM dashboards and/or UI's may also, or instead, be utilized.

The customer relationship management dashboard 300 may, in some embodiments, facilitate the summarization flow 200, 212, and/or 214 of FIGS. 2A-2C. As such, a second user (e.g., an organizational representative) may access the example customer relationship management dashboard 300 during an interaction with a first user (e.g., a member). After the resolution of an intent (e.g., the detection of an intent shift) and the extraction of the interaction span 206-1, the intent classification model 122 may classify the interaction span 206-1 as an intent 208-1 of the set of predefined intents 302. The interaction summarization component 116 may use the interaction span 206-1 and the classified intent 208-1 from the set of predefined intents 302 to generate a prompt for a summary 210-1. The interaction summarization component 116 may input the generated prompt into the generative model 118 to generate/output the summary 210-1. The interaction summarization component 116 may display the summary 210-1 for the second user to review via the editable summary text box 310. The second user may edit, amend, modify, etc. the summary 210-1 and save it (e.g., for quality/compliance purposes). A similar process may be used for any additional intents/summaries.

In another embodiment, the customer relationship management dashboard 300 facilitates the summarization flow 200, 212, and/or 214 with a revised intent. After the interaction summarization component 116 displays the summary 210-1 and the second user reviews via the editable summary text box 310, the second user may select a revised intent classification from the set of predefined intents 302. The second user may select the revise intent button 304 which may cause the customer relationship management component 132 to send the revised intent classification to the interaction summarization component 116 which generates a revised prompt using the revised intent classification and the interaction span 206-1. The interaction summarization component 116 may then input the revised prompt into the generative model 118 to generate/output a revised summary. The interaction summarization component 116 may then send the revised summary corresponding to the interaction span 206-1 and revised intent classification back to the customer relationship management component 132 for the second user to review via the editable summary text box 310.

In yet another embodiment, the customer relationship management dashboard 300 facilitates the summarization flow 200, 212, and/or 214, with the second user using the second user comments text box 306. During or shortly thereafter resolving the intent of a first user the second user may add additional context using the second user comments text box 306, and then select the submit button 308. The time corresponding to when the second user selects the submit button 308 may be used by the interaction summarization component 116 to inform which interaction span 206-1 and detected intent 208-1 to associate the second user comments with. The interaction summarization component 116 may generate a prompt for a summary 210-1 using the interaction span 206-1, the classified intent 208-1, and the second user comments. The interaction summarization component 116 may input the generated prompt into the generative model 118 to generate/output the summary 210-1. The interaction summarization component 116 may display the summary 210-1 to the second user to review via the editable summary text box 310. The second user may edit, amend, modify, etc. the summary 210-1 and save it (e.g., for quality/compliance purposes). A similar process may be used for any additional intents/summaries.

### EXAMPLE COMPUTER-IMPLEMENTED METHOD

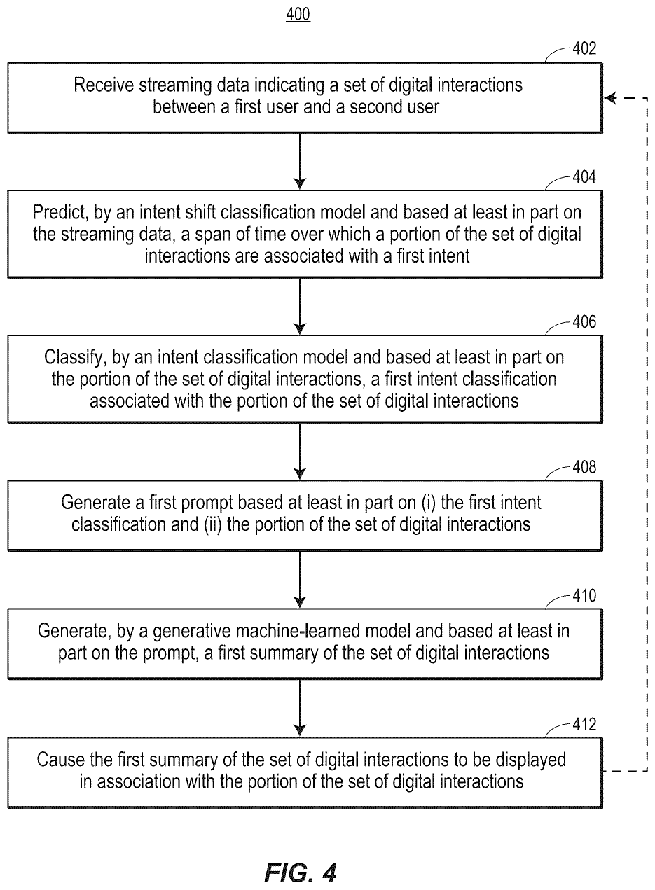

FIG. 4 depicts a flow diagram representing an example computer-implemented method 400. The method 400 may be implemented by one or more processors and/or devices of the example computing environment 100, such as the processors 112 and/or 128, the server 102 (e.g., using interaction summarization component 116), the computing device 104 (e.g., using customer relationship management component 132), the communication device 106, and/or the cloud contact center 110. The operations shown may be performed in the order shown or, in come embodiments, in a partially different order (or partially in parallel, etc.).

The method 400 includes receiving streaming data indicating a set of digital interactions (e.g., set of digital interactions 202) between a first user and a second user (operation 402). For example, a contact center (e.g., the cloud contact center 110) may integrate a voice analytics platform (VAP) and event hub to enable real-time, granular transcription of interaction by capturing the verbal and/or textual exchange between the first user (e.g., member) and the second user (e.g., organizational representative). The VAP and event hub may convert the spoken utterances into a textual format by means of suitable ASR software (e.g., Azure® STT). The streaming data may be received in real time and may consist of audio, video, textual, I/O, and or the like data types.

The method 400 also includes predicting, by an intent shift classification model (e.g., intent shift classification model 120) and based at least in part on the streaming data, a span of time over which a portion of the set of digital interactions (e.g., interaction portion 204-1) are associated with a first intent (operation 404). In some embodiments, the intent shift classification model 120 predicts a span based on a classified shift start determined at least in part by language associated with the beginning of an intent. The intent shift classification model 120 may classify a shift end based on language associated with the end of an intent. The intent shift classification model 120 may classify anything not associated with the beginning or end of an intent as no shift. When the interaction portion 204-1 includes a shift start and shift end, the interaction summarization component 116 may predict a span of time over which a portion of the set of digital interactions are associated with a first intent shift.

The method 400 also includes classifying, by an intent classification model (e.g., intent classification model 122) and based at least in part on the portion of the set of digital interactions (e.g., interaction span 206-1), a first intent classification (e.g., classified intent 208-1) associated with the portion of the set of digital interactions (operation 406). The intent classification model 122 may classify interaction spans 206-1 based on context, keywords, phrases, patterns, etc. indicative of the first user's intent. The interaction span 206-1 may be classified as an intent from the set of predefined intents 302.

The method 400 also includes generating, by the one or more processors, a first prompt based at least in part on (i) the first intent classification (e.g., classified intent 208-1) and (ii) the portion of the digital interaction (e.g., interaction span 206-1) (operation 408). For example, the interaction summarization component 116 may use the classified intent and the interaction span to generate a prompt. In some embodiments, the prompt may be generated by a generative model (e.g., a generative model other than generative model 118) prompted with the interaction span 206-1 and the classified intent 208-1. In other embodiments, the prompt may be generated using a pre-generated prompt template, with the classified intent 208-1 and interaction span 206-1 populating fields of the template according to a standardized prompt format/structure.

The method 400 also includes generating, by a generative machine-learned model (e.g., generative model 118) and based at least in part on the prompt, a first summary (e.g., summary 210-1) of the set of digital interactions (operation 410). The interaction summarization component 116 may prompt the generative model to generate/output the summary. For example, the generative model may process the prompt based on the interaction span 206-1 and the classified intent 208-1 to generate the summary such that the summary captures the essence of the interaction span related to the classified intent.

The method 400 also includes causing, by the one or more processors, the first summary of the set of digital interactions to be displayed in association with the portion of the set of digital interactions (operation 412). The interaction summarization component 116 may send the summary 210-1 to the customer relationship management component 132 for display. For example, the customer relationship management dashboard 300 may display the summary 210-1 using the editable summary text box 310. In some embodiments a second user may review the summary for accuracy, make any necessary edits, and use the information for further action or documentation purposes.

As depicted by the dashed line, the method 400 may repeat a respective iteration of operations 402 through 412 for each of one or more additional intent(s), in some embodiments. It should be understood that the various operations need not be performed strictly in the order depicted, (e.g., operation 402 may be performed in parallel with subsequent operations, and operation 402 for a second iteration may be performed while one or more other operations are performed for an earlier, first iteration.)

In some embodiments, the method 400 may include a second user selection of a portion of user metadata 124 to be included in the prompt. The portion of user metadata 124 may be selected from all the metadata associated with a first user (e.g., a member), all user metadata related to a presently selected intent, all user metadata related to a previously selected intent, etc. The second user selection of user metadata from the larger set of user metadata may allow for the inclusion of additional context or information related to the first user, which advantageously ensures that summaries are accurate. In other embodiments, the user metadata may be pre-populated by a generative model (e.g., generative model 118 or a different generative model) prompted with the larger set of user metadata and the classified intent extracting the relevant user metadata from the larger set of user metadata.

In some embodiments, the method 400 may include a user revision of the summary 210-1, 210-2, etc. using the editable summary text box 310. The user revision of the summary 210-1, 210-2, etc. may be stored as one or more suitable data objects such as a plain text file (e.g., .txt), structured text format (e.g., .JSON, .XML, .YAML, etc.), database tables (e.g., MySQL, PostgreSQL), and/or specialized transcript formats (e.g., .trs, .vtt). The user revision enables the second user to refine the summary 210-1, 210-2, etc. by making edits, deletions, additions, etc. ensuring that the final documentation accurately reflects the interaction's content and outcomes.

In some embodiments, the method 400 may include generating an overall summary of the interaction. The overall summary of the interaction may provide a comprehensive review that encapsulates the entire interaction, including all classified intents, second user comments, CRM-metadata, and any additional data and/or information used in the summarization process. The overall summary may serve as a complete record of the interaction.

It is to be understood that the actions of the method 400 may be performed any suitable number of times (e.g., to summarize multi-intent interactions), in any suitable order, and/or may include fewer, additional, or different actions.

### EXAMPLES

Example 1. A computer-implemented method comprising: receiving, by one or more processors, streaming data indicating a set of digital interactions between a first user and a second user; predicting, by an intent shift classification model and based at least in part on the streaming data, a span of time over which a portion of the set of digital interactions are associated with a first intent; classifying, by an intent classification model and based at least in part on the portion of the set of digital interactions, a first intent classification associated with the portion of the set of digital interactions; generating, by the one or more processors, a first prompt based at least in part on (i) the first intent classification and (ii) the portion of the set of digital interactions; generating, by a generative machine-learned model and based at least in part on the prompt, a first summary of the set of digital interactions; and causing, by the one or more processors, the first summary of the set of digital interactions to be displayed in association with the portion of the set of digital interactions.

Example 2. The computer-implemented method of Example 1, further comprising: predicting, by the intent shift classification model and based at least in part on the streaming data, a second span of time over which a portion of the set of digital interactions are associated with a second intent; classifying, by the intent classification model and based at least in part on the portion of the set of digital interactions, a second intent classification associated with the portion of the set of digital interactions; determining, by the one or more processors, that the first intent classification and the second intent classification are identical; generating, by the one or more processors, a second prompt based at least in part on (i) the first intent classification, (ii) the portion of the set of digital interactions associated with the first intent classification, and (iii) the portion of the set of digital interactions associated with the second intent classification; generating, by the generative machine-learned model and based at least in part on the second prompt, an updated summary of the set of digital interactions; and causing, by the one or more processors, the updated summary of the set of digital interactions to be displayed in association with the portions of the set of digital interactions.

Example 3. The computer-implemented method of Example 1 or 2, further comprising: receiving, by the one or more processors, a user revision of the first intent classification via a user interface; generating, by the one or more processors, a second prompt based at least in part on (i) the user revised first intent classification and (ii) the portion of the set of digital interactions; generating, by the generative machine-learned model and based at least in part on the second prompt, an updated summary of the set of digital interactions; and causing, by the one or more processors, the updated summary of the set of digital interactions to be displayed in association with the portions of the set of digital interactions.

Example 4. The computer-implemented method of any one of Examples 1-3, wherein predicting the span of time over which a portion of the set of digital interactions are associated with a first intent includes predicting the span of time over which a portion of the set of digital interactions are associated with a first intent as a start of a new intent or an end of a current intent.

Example 5. The computer-implemented method of Example 4, further comprising: classifying the first portion of the digital interaction as the first intent shift includes classifying the first portion of the interaction as the start of the new intent, the first span begins at a first digital interaction set of digital interactions; or classifying the first portion of the interaction as the first intent shift includes classifying the first portion of the interaction as the end of the current intent, the first span ends at the first portion of the interaction.

Example 6. The computer-implemented method of any one of Examples 1-5, further comprising: receiving, by the one or more processors, service interaction data indicating the second user's interaction with a hosted service; wherein predicting the span of time over which a portion of the set of digital interactions is associated with a first intent is based at least in part on the service interaction data, wherein classifying the intent classification associated with the portion of the set of digital interactions is based at least in part on the service interaction data.

Example 7. The computer-implemented method of any one of Examples 1-6, further comprising: receiving, by the one or more processors, service interaction data indicating the second user's interaction with a hosted service; and generating, by the one or more processors, training data for the intent shift classification model and the intent classification model based on the service interaction data.

Example 8. The computer-implemented method of any one of Examples 1-7, wherein generating the first prompt is based at least in part on (i) the first intent, (ii) the first span, and (iii) user metadata.

Example 9. The computer-implemented method of Example 8, wherein generating the first prompt includes extracting the user metadata from a larger set of user metadata by prompting the generative model, or a different generative model, with at least the larger set of user metadata and the first classified intent.

Example 10. The computer-implemented method of any one of Examples 1-9, wherein the first intent is classified as an intent from a set of predefined intent, and wherein causing the first summary of the interaction to be displayed occurs during the interaction and via the user interface.

Example 11. The computer-implemented method of any one of Examples 1-10, further comprising: receiving, by the one or more processors, a user revision of the first summary or the updated summary of the interaction via the user interface; and storing, by the one or more processors, one or more data objects representing the user revision of at least one of the first summary or the updated summary.

Example 12. The computer-implemented method of any one of Examples 1-11, further comprising: receiving, by the one or more processors, a user revision of the first summary of the interaction via the user interface; and storing, by the one or more processors, one or more data objects representing the user revision of the first summary of the interaction.

Example 13. The computer-implemented method of any one of Examples 1-12, further comprising: generating, by the one or more processors and after the interaction, an overall summary of the interaction, wherein generating the overall summary of the interaction includes inputting an overall summary prompt into a generative model, and wherein the overall summary prompt includes the interaction and at least one classified intent.

Example 14. A system comprising: one or more processors; and one or more memories storing processor-executable instructions that, when executed by the one or more processors, cause the one or more processors to perform operations comprising the method of any one of Examples 1-13.

Example 15. One or more non-transitory computer-readable media storing processor-executable instructions that, when executed by one or more processors, cause the one or more processors to perform operations comprising the method of any one of Examples 1-13.

### ADDITIONAL CONSIDERATIONS

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A computer-implemented method comprising:
receiving, by one or more processors, streaming data indicating a set of digital interactions between a first user and a second user;
predicting, by an intent shift classification model and based at least in part on the streaming data, a span of time over which a portion of the set of digital interactions are associated with a first intent;
classifying, by an intent classification model and based at least in part on the portion of the set of digital interactions, a first intent classification associated with the portion of the set of digital interactions;
generating, by the one or more processors, a first prompt based at least in part on (i) the first intent classification and (ii) the portion of the set of digital interactions;
generating, by a generative machine-learned model and based at least in part on the prompt, a first summary of the set of digital interactions; and
causing, by the one or more processors, the first summary of the set of digital interactions to be displayed in association with the portion of the set of digital interactions.

2. The computer-implemented method of claim 1, further comprising:
predicting, by the intent shift classification model and based at least in part on the streaming data, a second span of time over which a portion of the set of digital interactions are associated with a second intent;
classifying, by the intent classification model and based at least in part on the portion of the set of digital interactions, a second intent classification associated with the portion of the set of digital interactions;
determining, by the one or more processors, that the first intent classification and the second intent classification are identical;
generating, by the one or more processors, a second prompt based at least in part on (i) the first intent classification, (ii) the portion of the set of digital interactions associated with the first intent classification, and (iii) the portion of the set of digital interactions associated with the second intent classification;
generating, by the generative machine-learned model and based at least in part on the second prompt, an updated summary of the set of digital interactions; and
causing, by the one or more processors, the updated summary of the set of digital interactions to be displayed in association with the portions of the set of digital interactions.

3. The computer-implemented method of claim 1, further comprising:
receiving, by the one or more processors, a user revision of the first intent classification via a user interface;
generating, by the one or more processors, a second prompt based at least in part on (i) the user revised first intent classification and (ii) the portion of the set of digital interactions;
generating, by the generative machine-learned model and based at least in part on the second prompt, an updated summary of the set of digital interactions; and
causing, by the one or more processors, the updated summary of the set of digital interactions to be displayed in association with the portions of the set of digital interactions.

4. The computer-implemented method of claim 1, wherein predicting the span of time over which a portion of the set of digital interactions are associated with a first intent includes predicting the span of time over which a portion of the set of digital interactions are associated with a first intent as a start of a new intent or an end of a current intent.

5. The computer-implemented method of claim 4, wherein at least one of:
classifying the first portion of the set of digital interactions as the first intent shift includes classifying the first portion of the interaction as the start of the new intent, the first span begins at a first digital interaction set of digital interactions; or
classifying the first portion of the set of digital interactions as the first intent shift includes classifying the first portion of the set of digital interactions as the end of the current intent, the first span ends at the first portion of the set of digital interactions.

6. The computer-implemented method of claim 1, further comprising:
receiving, by the one or more processors, service interaction data indicating the second user's interaction with a hosted service; and
wherein predicting the span of time over which a portion of the set of digital interactions is associated with a first intent is based at least in part on the service interaction data,
wherein classifying the intent classification associated with the portion of the set of digital interactions is based at least in part on the service interaction data.

7. The computer-implemented method of claim 1, further comprising:
receiving, by the one or more processors, service interaction data indicating the second user's interaction with a hosted service; and
generating, by the one or more processors, one or both of (i) training data for the intent shift classification model, and (ii) training data for the intent classification model, based on the service interaction data.

8. A system comprising:
one or more processors; and
one or more memories storing processor-executable instructions that, when executed by the one or more processors, cause the one or more processors to perform operations comprising:
receiving a set of digital interactions between a first user and a second user;
predicting, by an intent shift classification model, a span of time over which a portion of the set of digital interactions are associated with a first intent;
classifying, by an intent classification model and based at least in part on the portion of the set of digital interactions, a first intent classification associated with the portion of the set of digital interactions;
generating a first prompt based at least in part on (i) the first intent classification and (ii) the portion of the set of digital interactions;
generating, by a generative machine-learned model and based at least in part on the prompt, a first summary of the set of digital interactions; and
causing the first summary of the set of digital interactions to be displayed in association with the portion of the set of digital interactions.

9. The system of claim 8, further comprising processor-executable instructions that when executed by the one or more processors, cause the one or more processors to perform operations comprising:
predicting, by the intent shift classification model, a second span of time over which a portion of the set of digital interactions are associated with a second intent;
classifying, by the intent classification model and based at least in part on the portion of the set of digital interactions, a second intent classification associated with the portion of the set of digital interactions;
determining that the first intent classification and the second intent classification are identical;
generating a second prompt based at least in part on (i) the first intent classification, (ii) the portion of the set of digital interactions associated with the first intent classification, and (iii) the portion of the set of digital interactions associated with the second intent classification;
generating, by the generative machine-learned model and based at least in part on the second prompt, an updated summary of the set of digital interactions; and
causing the updated summary of the set of digital interactions to be displayed in association with the portions of the set of digital interactions.

10. The system of claim 8, further comprising processor-executable instructions that when executed by the one or more processors, cause the one or more processors to perform operations comprising:
receiving a user revision of the first intent classification via a user interface;
generating a second prompt based at least in part on (i) the user revised first intent classification and (ii) the portion of the set of digital interactions;
generating, by the generative machine-learned model and based at least in part on the second prompt, an updated summary of the set of digital interactions; and
causing the updated summary of the set of digital interactions to be displayed in association with the portions of the set of digital interactions.

11. The system of claim 8, wherein predicting the span of time over which a portion of the set of digital interactions are associated with a first intent includes predicting the span of time over which a portion of the set of digital interactions are associated with a first intent as a start of a new intent or an end of a current intent.

12. The system of claim 11, wherein:
classifying the first portion of the set of digital interactions as the first intent shift includes classifying the first portion of the interaction as the start of the new intent, the first span begins at a first digital interaction set of digital interactions; or
classifying the first portion of the set of digital interactions as the first intent shift includes classifying the first portion of the set of digital interactions as the end of the current intent, the first span ends at the first portion of the set of digital interactions.

13. The system of claim 8, further comprising processor-executable instructions that when executed by the one or more processors, cause the one or more processors to perform operations comprising:
receiving service interaction data indicating the second user's interaction with a hosted service;
wherein predicting the span of time over which a portion of the set of digital interactions is associated with a first intent is based at least in part on the service interaction data,
wherein classifying the intent classification associated with the portion of the set of digital interactions is based at least in part on the service interaction data.

14. The system of claim 8, further comprising processor-executable instructions that when executed by the one or more processors, cause the one or more processors to perform operations comprising:
receiving service interaction data indicating the second user's interaction with a hosted service; and
generating one or both of (i) training data for the intent shift classification model, and (ii) training data for the intent classification model, based on the service interaction data.

15. One or more non-transitory computer-readable media storing processor-executable instructions that, when executed by one or more processors, cause the one or more processors to perform operations comprising:
receiving a set of digital interactions between a first user and a second user;
predicting, by an intent shift classification model, a span of time over which a portion of the set of digital interactions are associated with a first intent;
classifying, by an intent classification model and based at least in part on the portion of the set of digital interactions, a first intent classification associated with the portion of the set of digital interactions;
generating a first prompt based at least in part on (i) the first intent classification and (ii) the portion of the set of digital interactions;
generating, by a generative machine-learned model and based at least in part on the prompt, a first summary of the set of digital interactions; and
causing the first summary of the set of digital interactions to be displayed in association with the portion of the set of digital interactions.

16. The one or more non-transitory computer-readable media of claim 15, wherein the processor-executable instructions, when executed by the one or more processors, cause the one or more processors to perform operations further comprising:
predicting, by the intent shift classification model, a second span of time over which a portion of the set of digital interactions are associated with a second intent;
classifying, by the intent classification model and based at least in part on the portion of the set of digital interactions, a second intent classification associated with the portion of the set of digital interactions;
determining that the first intent classification and the second intent classification are identical;
generating a second prompt based at least in part on (i) the first intent classification, (ii) the portion of the set of digital interactions associated with the first intent classification, and (iii) the portion of the set of digital interactions associated with the second intent classification;
generating, by the generative machine-learned model and based at least in part on the second prompt, an updated summary of the set of digital interactions; and
causing the updated summary of the set of digital interactions to be displayed in association with the portions of the set of digital interactions.

17. The one or more non-transitory computer-readable media of claim 15, wherein the processor-executable instructions, when executed by the one or more processors, cause the one or more processors to perform operations further comprising:
receiving a user revision of the first intent classification via a user interface;
generating a second prompt based at least in part on (i) the user revised first intent classification and (ii) the portion of the set of digital interactions;
generating, by the generative machine-learned model and based at least in part on the second prompt, an updated summary of the set of digital interactions; and
causing the updated summary of the set of digital interactions to be displayed in association with the portions of the set of digital interactions.

18. The one or more non-transitory computer-readable media of claim 15, wherein predicting the span of time over which a portion of the set of digital interactions are associated with a first intent includes predicting the span of time over which a portion of the set of digital interactions are associated with a first intent as a start of a new intent or an end of a current intent.

19. The one or more non-transitory computer-readable media of claim 18, wherein:
classifying the first portion of the set of digital interactions as the first intent shift includes classifying the first portion of the interaction as the start of the new intent, the first span begins at a first digital interaction set of digital interactions; or
classifying the first portion of the set of digital interactions as the first intent shift includes classifying the first portion of the set of digital interactions as the end of the current intent, the first span ends at the first portion of the set of digital interactions.

20. The one or more non-transitory computer-readable media of claim 15, wherein the processor-executable instructions, when executed by the one or more processors, cause the one or more processors to perform operations further comprising:
receiving service interaction data indicating the second user's interaction with a hosted service;
wherein predicting the span of time over which a portion of the set of digital interactions is associated with a first intent is based at least in part on the service interaction data,
wherein classifying the intent classification associated with the portion of the set of digital interactions is based at least in part on the service interaction data.
